(19) United States
(12) Patent Application Publication
(10) Pub. No.: US 2002/0097725 A1
(43) Pub. Date: Jul. 25, 2002

(54) Resource and protocol management for virtual private networks within multiprocessor ATM switches

(75) Inventors: Rajiv Dighe, Princeton, NJ (US); Subir K. Biswas, Plainsboro, NJ (US); Vasanthi Thirumalai, Cliffwood, NJ (US); Kojiro Watanabe, Cranbury, NJ (US); Gopalakrishnan Ramamurthy, Cranbury, NJ (US)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/082,158

(22) Filed: Feb. 26, 2002

Related U.S. Application Data
(62) Division of application No. 09/241,049, filed on Feb. 1, 1999.
(60) Provisional application No. 60/094,197, filed on Jul. 27, 1998.

(51) Int. Cl. H04L 12/28; H04L 12/56

(52) U.S. Cl. 370/395.1; 370/409

(57) ABSTRACT

An overlay model to let multiple VPNs share the same physical switches while maintaining their individual resource and administrative boundaries. A clean resource and protocol management structure within the ATM switches is provided for the overlay model. An architectural framework for such resource and protocol management within multiprocessor ATM switches is provided. Multiple protocols are supported both at the switch level and at the port level. A VPN on a switch can be configured with any of the existing control protocols available on that switch. This protocol management mechanism is then extended for providing intra-VPN multiprotocol support where a single VPN is allowed to use multiple control protocols on the same switch port. A mechanism for Network Management System (NMS) coordinated VPN creation and configuration is provided.

### I. DESCRIPTION OF THE INVENTION

This application claims priority from co-pending U.S. Provisional Patent Application Serial No.60/094,197 filed on Jul. 27, 1998.

### IA. FIELD OF THE INVENTION

The present invention relates to virtual private networks (VPNs). Specifically the present invention provides a framework for resource and protocol management for VPNs within multiprocessor ATM switches. The present invention is embodied in an ATM network system, virtual private network systems and a method for creating VPN services in a VPN system.

### IB. BACKGROUND

The present Application is related to U.S. patent application Ser. No. 09/184,610 [hereinafter 3 610], U.S. patent application Ser. No. 09/187,297, and U.S. patent application Ser. No. A7249 titled An Open Control-Software Architecture for Multiprocessor ATM Switches by Dighe et al. [hereinafter***],which are all incorporated herein by reference.

With the recent proliferation of internet and its services, more and more corporate users are relying on the internet for their day-to-day business requirements. As a result of the customized service demands of today's corporate users, together with individual security concerns, a desire for private networking services is evolving within the enterprise internet user community. Introduction of the Virtual Private Networking (VPN) is aimed at offering customized network services within the existing internet framework. See C. Scott, P. Wolfe and M. Erwin, “Virtual Private Networks,” IEEE Computer Society Press, February 1998 and T. Kato, K. Omachi and S. Tanabe, “BVPN (Broadband Virtual Private Network): A Flexible, High-speed, Enterprise Network Architecture”, Proceedings of the Fifth IEEE Computer Society Conference on Future Trends of Distributed Computing System, August 1995.

At the highest level of abstraction, a VPN is a logical network which when appropriately configured, can be assigned to a specific multi-site user for the customized service requirements of the user. A logical network is considered to be an overlay on an existing physical network and the resources associated with the physical network. An example of a simple VPN is a Permanent Virtual Circuit (PVC) with resources assigned to it. See “ATM User Network Interface (UNI) Specification Version 4.0, AF-SIG-0061.000,” ATM Forum, July 1996 and “Private Network-Network Interface Specification version 1.0, AF-PNNI-0055.000,” ATM Forum, September 1996. Once a PVC is allotted to a network customer, within the constraints of the resources reserved for the PVC, the customer can use the virtual circuit completely at the user's discretion. Possible customizations include data multiplexing within the PVC, data compression and end-to-end data encryption. An essential purpose of having a VPN is to provide customized services to a specific customer without affecting the other users of the network.

In the next lower level of abstraction, the VPN uses multiple PVCs for creating an overlay mesh. See M. C. Chan, H. Hadama and R. Stadler, “An Architecture for Broadband Virtual Networks under Customer Control,” Proceedings of the IEEE Symposium on Network Operations and Management, April 1996. Once such a mesh VPN is configured, the owner of the mesh VPN can run a customized signaling protocol to set up connections within the mesh VPN. For a mesh VPN, other customized processes that need to be performed include routing, call admission control, cell-level scheduling, accounting, billing and several other ATM management-plane functions. See D. Ginsburg, “ATM: Solutions for Enterprise networking,” Addison-Wesley, Harlow, UK, 1996.

Conventionally, many forms of VPNs have been defined for both IP and ATM-based internet backbones. See “A Framework for IP Based Virtual Private Network,” Internet Draft of Internet Engineering Task Force, February 1998 and P. Coppo, M. D'Ambrosio and V. Vercellone, “The A-VPN Server: A Solution for ATM Virtual Private Networks”, Proceedings of Singapore ICCS'94, November 1994. Functionally, these VPNs range from simple end-to-end tunnels (e.g. PVC) to a full-blown overlay of resource-reserved mesh, as described above. Regardless of the model adopted, a network switching device that provides a clean mechanism for partitioning and reserving its resources for the participating VPNs within the network is required.

### II. SUMMARY OF THE PRESENT INVENTION

An objective of the present invention is to provide an architecture for partitioning and reserving resources within ATM switches for creating and maintaining VPNs.

Another objective of this invention is to provide VPN software modularity. Such a software modularity allows the reuse of part of the VPN software on varieties switching platforms.

Still another objective of the present invention is to provide a framework for VPN service level management for creation, termination and maintenance of the private networks.

In order to meet the objectives of the present invention there is provided an ATM network system with an architecture for the implementation of resource and protocol management for supporting an overlay of one or more virtual private networks (VPN) within said ATM network, said system comprising partitioned port line resources for supporting said VPNs, partitioned switch processing resources for supporting said VPNs, a resource reserver for reserving resources for individual VPNs, switch ports that can be configured for multiple control protocols, protocol assignor for assigning control protocols to individual VPNs and a service creation manager for creating and deleting VPN services.

Another aspect of the present invention is a virtual private network system comprising one or more VPNs, said one or more VPNs being overlaid on an ATM network, said VPN system allowing a customer to be present at a plurality of sites, wherein any ATM switch and any ATM port can be shared by a subset of said one or more VPNs, wherein two levels of multiprotocol support is provided, a first level of multiprotocol support being an ability for any VPN from said one or more of VPNs to choose any protocol without affecting VPNs different from said any VPN, a second level of multiprotocol support being an ability for any VPN from said one or more of VPNs to choose more than one protocol over a switch.

Yet another aspect of the present invention is a virtual private network system comprising one or more VPNs being overlaid on an ATM network, wherein a port resource management layer is provided between a line card and a signaling protocol controlling said line card, wherein said PRML provides a mechanism for logically partitioning available resources and bundling said resource into VPN specific resource modules (VPNRM), said VPNRMs being allocated to said VPNs.

Preferably, each of said VPNRMs is owned by one of said VPNs and said one of said VPNs is free to choose an authentication and security model for accessing available resources.

Preferably, each of said VPNRMs exports a VPN-specific secured interface (VSSI), said VSSI being used by a protocol signaling module for controlling partitioned resources owned by a VPN.

Preferably, each of said one or more VPNs is capable of using multiple control protocols on a same switch by creating a VPNRM each for each of said multiple control protocols.

Preferably, each of said one or more VPNs uses an independent control protocol on a switch by creating a VPNRM for said independent control protocol.

Preferably, each of said VPNRMs is registered with a protocol object by sending an allocated resource information corresponding to said each of said VPNRM to a protocol module, wherein said protocol module uses said resource information to allocate resources including VPI, VCI, buffers, cell-level scheduling priority and call admission control execution.

Preferably, when a connection setup message is received a line card hardware delivers the message to an appropriate VSSI interface through an appropriate VPNRM, said appropriate VPNRM being chosen based on a specific control requirement corresponding to a VPN associated with the message.

Still preferably, a VPNRM is chosen by partitioning an available VPI space and VCI space of a switch port and selecting a VPNRM within the VPN using additional information within the message itself.

Preferably, the system further comprises a network management system (NMS) on the network and an NMS agent that runs within an element manager card, wherein said NMS agent and NMS manager communicate with each other and said NMS agent coordinates local network management operations including VPN management, protocol downloading, device configuration, resource configuration, measurement and billing.

Another aspect of the present invention is a method of creating VPN services in a VPN system comprising a central protocol manager module, a plurality of port resource managers (PRM), a plurality of VPNRMs, a protocol signaling module, a line card, an NMS manager and an NMS agent, said method comprising: instructing the NMS agent by the NMS manager for creating the VPN and providing VPN-specific information; performing authentication and validation by the NMS agent and forwarding a request to said CPMM; sending configuration request from the CPMM to said plurality of PRMs; configuring the plurality of VPNRMs by the PRMs with specified amount of resources required and sending a fault message if the resources are not available; communicating with the CPMM by the PRMs to obtain a reference for a desired control protocol module for a switch; passing the VPNRM configuration information by the PRMs to the protocol signaling module; creating binding between said VPNRMs and corresponding signaling modules; sending control message demultiplexing information to the line card; and sending information on success or failure to the CPMM, NMS agent and NMS manager

### III. LIST OF FIGURES

The above objectives and advantages of the present invention will become more apparent by describing in detail preferred embodiments thereof with reference to the attached drawings in which:

FIG. 1 shows an example of a VPN model on ATM switches.

FIG. 2 shows an embodiment of the present invention illustrating port resource management for supporting VPNs.

FIG. 3 shows an embodiment of the present invention illustrating multiple protocol support for VPNs.

FIG. 4 shows a preferred embodiment of a VPN system according to the present invention.

FIG. 5 illustrated steps in creating VPN services on a switch port.

### IV. DETAILED DESCRIPTION OF THE PRESENT INVENTION

The present invention is partially based on a network-control paradigm in which a VPN owner is allowed to run multiple control/signaling protocols within its own VPN. Support of such a multiprotocol control is an important feature of this invention. It allows different connections (belonging to a single VPN) on a single switch port to be controlled by different control protocols.

A potential application of this software architecture is the multiprocessor switching device described in '610 were a processor is assumed to be available on each of the port line cards. ATM edge switches form another potential application platform for the present invention. See G. Ramamurthy, R. Fan, A. Ishi and B. Mark, “Next Generation Edge Switch Architecture,” NEC USA Internal Document, Advanced Development Department, December 1997.

This design can be implemented on an ATM open-control framework which is described in ***. The architecture disclosed in the *** application provides a bottom-up mechanism for supporting resource partition and reservation within multiprocessor switching devices. The *** architecture also has a clean mechanism for incorporating multiple control protocols on a switch port.

A key aspect of the present invention is the use of the port-resource management layer of the architecture described in *** for implementing VPN resource and protocol management functions.

There are several key features that form the core of the present invention. According to the present invention, line-resources within the network are partitioned to provide VPN support. Further resources for switch processing functions are also partitioned for VPN support. The present invention also provides for mechanisms for reserving resources for individual VPNs. Multiple control protocols can be configured on a single switch port. Mechanisms are provided for assigning control protocols to the VPNs. Another key aspect of the invention is the provision of management support for VPN service creation and deletion

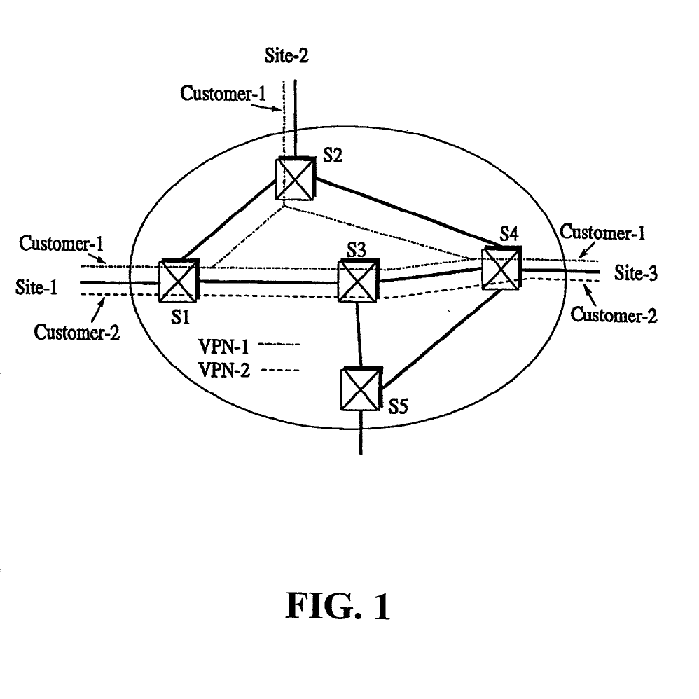

An embodiment of a VPN model representing the resource management architecture of the present invention is described herein. An overlay model, shown in FIG. 1, forms the basis of the present embodiment. In this model two VPNs are created on an ATM network with five switches and eight links. The bold lines represent physical ATM links. VPN-1, spanning through switches S1, S2, S3 and S4, is allocated to customer-1. This customer is present at site-1, site-2 and site-3. Similarly, VPN-2, which spans through S1, S3 and S4, is assigned to customer-2, who has presence at site-1 and site-3. Note that this VPN model allows a single customer to be present at more than one sites. The presence of a customer at more than one site makes it particularly suitable for corporate customers who require customized network services among multiple sites that are geographically apart.

Note that in the overlay framework that is described, an ATM switch can be shared by multiple VPNs both at the switch level and at the port level. For example, the switch S1 is shared by both the VPNs. Further, two of its ports (port connecting site-1 and port connecting switch S3) are shared by the VPNs. Such a sharing requires resource partitioning, reservation and management mechanism to be in place within the switch. The present invention specifically provides an architectural framework for both line and processor resource management for VPNs, acting on ATM switches.

Once a VPN is created, its owner customer can use either PVCs or SVCs (Switched Virtual Circuit) within the VPN. In case SVCs are chosen, the customer can also choose its own signaling protocol, e.g. Distributed ATM signaling or UNNI/PNNI, for connection setup and other ATM control-plane operations. See M. Veeraraghavan, T. F. La Porta and W. S. Lai, “An Alternative Approach to Call/Connection Control in Broadband Switching Systems,” IEEE Communications Magazine, November 1995, pp. 90-95; “ATM User Network Interface (UNI) Specification Version 4.0, AF-SIG-0061.000,” ATM Forum, July 1996; and “Private Network-Network Interface Specification version 1.0, AF-PNNI-0055.000,” ATM Forum, September 1996). If the customer wants to support packet based services like IP within the VPN, it is free to choose a specific Packet-based control protocol.

It should be emphasized that, once configured appropriately, a VPN customer can choose any signaling/control protocol without affecting the other VPNs that are sharing the same ATM links and switches. For example, in FIG.1, customer-1 and customer-2 can use completely different signaling protocols for setting up SVCs within VPN-1 and VPN-2. Because of such a sharing, in addition to appropriately reserving resources and partitioning, the participating ATM switches are required to support multiple control protocols on the same switch port.

In the next level of multiprotocol support, the present invention allows a single VPN to use multiple signaling/control protocols over a switch port. In such a scenario, different sessions within the same VPN can use different control protocols based on their specific performance requirements. This can be better explained with an example. Consider that customer-i in FIG.1 has a machine connected to VPN-1 in site-1. For an IP-Telephony session on that machine, the end-application might prefer to use a control protocol like IF-over-ATM using MPOA. See “Multi-Protocol Over ATM Version 1.0, AF-MPOA-0087.000,” ATM Forum, July 1997. However, for World Wide Web (WWW) traffic from the same machine, the web applications might prefer an IP switching protocol like Ipsilon IP-Switching. See P. Newman et al, “Flow Switching: To Switch or Not to Switch,” NSF Workshop on Internet Statistics Measurements, March 1996. In this situation, VPN-1 needs to support both MPOA and Ipsilon protocol stacks on the port (corresponding to switch S1) which is connected to site-1. The choice of different control protocols is based solely on the application performance requirements. The VPN resource management and protocol support architecture of the present invention allows this level of multiple protocol support within a singleVPN.

The architecture of the present invention also provides the necessary management functions for creating and terminating the VPNs dynamically. This involves creating and destroying resource modules within the switch ports. This invention, working with an open control architecture described in provides all the switch level functions which are required for supporting the presented VPN model.

### IV.A. Port Resource Management for Supporting VPNs

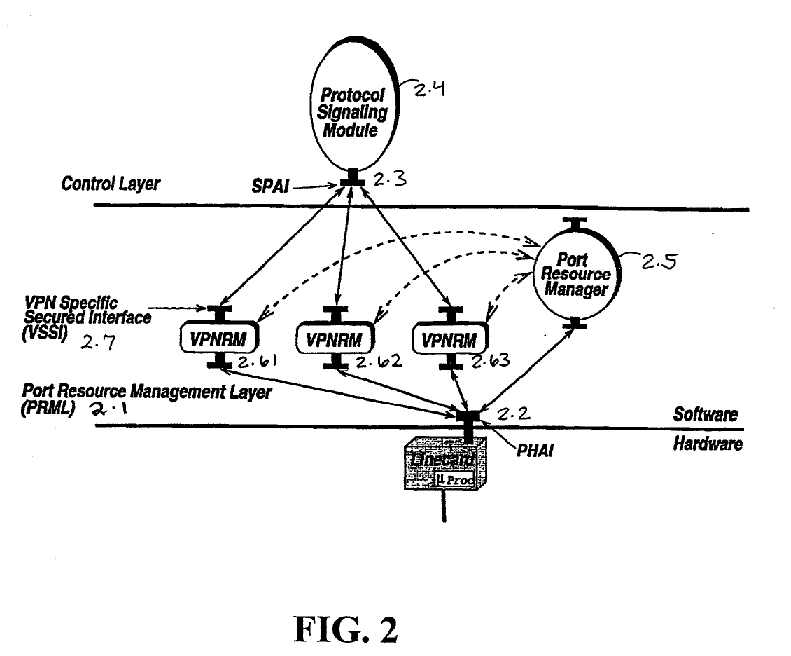

The present invention provides a mechanism for VPN-specific partitioning of the switch port resources. An embodiment of the resource partitioning framework of the present invention is illustrated in FIG. 2. A layer of software, namely Port-resource Management Layer (PRML) 2.1, is provided between a line card and the signaling protocol which controls the line card.

The software interface PHAI (Port Hardware Access Interface) 2.2 is used for providing access to the low-level line card resources including VCI/VPI table, input/output buffers and the cell scheduling parameters. In addition, it is also possible to obtain the line card configuration and various traffic and error statistics information through this interface 2.2. In general, given the right access permissions, any control entity can manipulate the line card resources through the PHAI interface 2.2. A similar interface SPAI (Signaling Protocol Access Interface) 2.3 implements the controller counterpart of PHAI. Using this interface 2.3, a line card delivers control messages to the signaling protocol module. For the protocol module, it also serves as a general purpose mailbox through which various asynchronous alarm events from the line cards are delivered. These two interfaces together, implement the basis for an Open Control paradigm within the ATM switch. More details can be found in ***.

The Port-resource Management Layer (PRML) 2.1 provides a mechanism for logically partitioning the available resources and bundling them into VPN specific Resource Modules or VPNRMs 2.61-2.63. Once partitioned, these resource modules are allocated to specific VPNs which are active on the port in question. The port-specific resources, managed by a PRML associated with a are switching bandwidth, VPI/VCI space, input/output buffer space and local processing cycles required for cell-level scheduling.

Based on a pre-defined policy (static and/or dynamic), the PRML partitions these resources and allocates a part of it to a VPNRM, whenever the VPNRM is created. Each VPNRM is owned by a specific VPN and the owner VPN is free to choose its own authentication and security model for the access to the corresponding resources. In addition, a VPNRM exports a VPN-specific Secured Interface (VSSI) 2.7 which is used by the protocol signaling module for controlling the partitioned resources, owned by a VPN. A VSSI interface offers all the PHAI functionalities with added inter-module security and resource protection. Further description of VSSI functionality can be found in ***.

Each VPNRM is identified by three parameters, namely, its associated port-id, protocol-type and aVPN-id. While the port-id simply refers to the physical port on which the resource module is created, the protocol-type points to a particular type of signaling protocol module that should control that particular VPNRM. The VPN-id indicates the identification of the VPN itself. Within the port-resource management layer corresponding to each port, there is a Port Resource Manager (PRM) 2.5 which is responsible for partitioning the available resources and allocating them to the VPNRMs. The PRM 2.5 is also responsible for creating, deleting and managing the resource modules.

How all the components of the PRML cooperate is described herein. During the creation of a VPN, the port resource manager corresponding to the port is informed about the signaling protocol which the VPN needs to use on that port. The port resource manager also receives information about the amount of line card resources requested by the VPN. Based on this information, the PRM creates a resource module and allocates the desired amount of line card resources to the newly created module. Then a resource module-to-protocol binding is established so that the resource module knows which protocol module to interact with for its control purposes.

This point onwards, a VPNRM and its associated signaling protocol module, together control and maintain the connections which arrive through the residing port and belong to the logical network, owned by that particular VPN. Inter-VPNRM resource violations are trapped at this layer and appropriate corrective actions are taken. Upon receiving the termination instruction from higher layer management entities, the port resource manager deletes the corresponding VPNRMs. In this scenario, such a termination request happens when the VPN decides to withdraw services from this particular port of the switch. Once a resource module is terminated, its resources are reclaimed by the port resource manager and are used for reallocation to VPNRMs to be created in future.

### IV. B. Multiprotocol Implementation

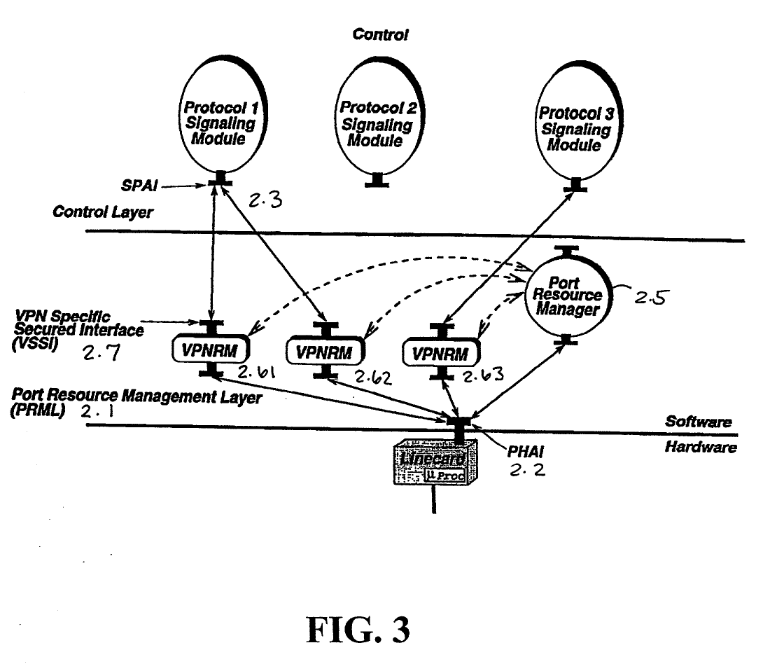

The VPN resource management layer can support multiple protocols as shown in FIG. 3. A list of supported signaling protocols includes

ATM forum standard UNMINNI.

Distributed ATM signaling. See M. Veeraraghavan, T. F. La Porta and W. S. Lai, “An Alternative Approach to Call/Connection Control in Broadband Switching Systems,” IEEE Communications Magazine, November 1995, pp. 90-95.

Circuit Emulation. See D. Ginsburg, “ATM: Solutions for Enterprise networking,” Addison-Wesley, Harlow, UK, 1996.

IP-over-ATM (RFC 1577, 1483).

IP-over-ATM using MPOA. See “Multi-Protocol Over ATM Version 1.0, AF-MPOA0087.000,” ATM Forum, July 1997.

Ipsilon IP-Switching. See P. Newman et al, “Flow Switching: To Switch or Not to Switch,” NSF Workshop on Internet Statistics Measurements, March 1996.

Tag switching. See D. Ginsburg, “ATM: Solutions for Enterprise networking,” Addison-Wesley, Harlow, UK, 1996.

CSR switching. See D. Ginsburg, “ATM: Solutions for Enterprise networking,” Addison-Wesley, Harlow, UK, 1996.

Ipsofacto. See A. Acharya et al, “IP Switching Over Fast ATM Cell Transport (IPSOFACTO),” Proceedings of IEEE Globecom '97, Phoenix, Ariz., December 1997.

IEIF MPLS.

PCS-over-ATM. See S. K. Biswas and V. Thirumalai, “A Framework for PCS Service Integration within ATM Networks,” NEC USA Technical Report, February 1998 (e.g. GSMover-ATM).

There is no one-to-one coupling between a particular signaling protocol module and a VPNRM on the port. Multiple VPNRMs can use a single protocol module to execute their signaling requirements. The reverse however is not true; meaning a VPNRM is never allowed to communicate with multiple protocol modules even if their protocol types are same. Since different VPNRMs can be controlled by different signaling protocols, the first signaling requirement of the VPN model is satisfied within this architecture. That is, each VPN can choose its own control protocol without affecting the operations of the other VPNs operating on the same switch port.

The second requirement of the VPN model is to let a VPN use multiple control protocols on the same switch port. To incorporate this, a single VPN can create multiple VPNRMs on the same switch port, depending on its control protocol requirements. Assume that a VPN needs to support both MPOA and Ipsilon IP-Switching protocols on the same switch port. This can be achieved by creating two VPNRMs and associating one with an MPOA protocol signaling module and the other with an IF-Switching module.

Whenever a VPNRM gets registered with a protocol object, it sends its own allocated resource information to the protocol module. The control protocol module uses this resource information to allocate several items to the connections, belonging to the resource module, including VPI/VCI, Buffers, Cell-level scheduling priority and Call Admission Control (CAC).

The above mechanism assures the protection of inter-VPNRM resources when multiple VPNRMs are controlled by a single signal protocol module.

In order for this multiprotocol VPN framework to work, a clean mechanism for demultiplexing signaling messages at the line card hardware level is required. When a connection setup message is received, the line card hardware is required to deliver the message to the appropriate VSSI interface. This is done through the appropriate VPNRM. First a decision needs to be made regarding which VPN this signaling message belongs to. Then a specific VPNRM should be chosen, based on specific control requirement.

The first level of demultiplexing is done by partitioning the available signaling VPI, VCI space of a particular switch pod. Consider a scenario where two VPNs need to run UNI/NNI signaling on a single switch port but each require independent control on their respective VPNRMs. This is achieved by partitioning the signaling VPI/VCI space for different owners. An example of this would be the use VPI 0, VCI 5 as the signaling channel for VPN-1 and the use of VPI 0, VCI 6 as the signaling channel for VPN-2. This partition information is conveyed to the switches during the configuration of the VPNs during their creation. The second level of demultiplexing, that is the selection of a specific VPNRM within the chosen VPN, is performed by using additional information within the control message itself. The present invention uses additional Information Elements (IE) within the signaling/control message for encoding the specific control protocol requirements. This information, together with the signaling VPI/VCI space partition, is used for dispatching an incoming signaling message to its corresponding appropriate VPNRM.

### IV.C Preferred Embodiment

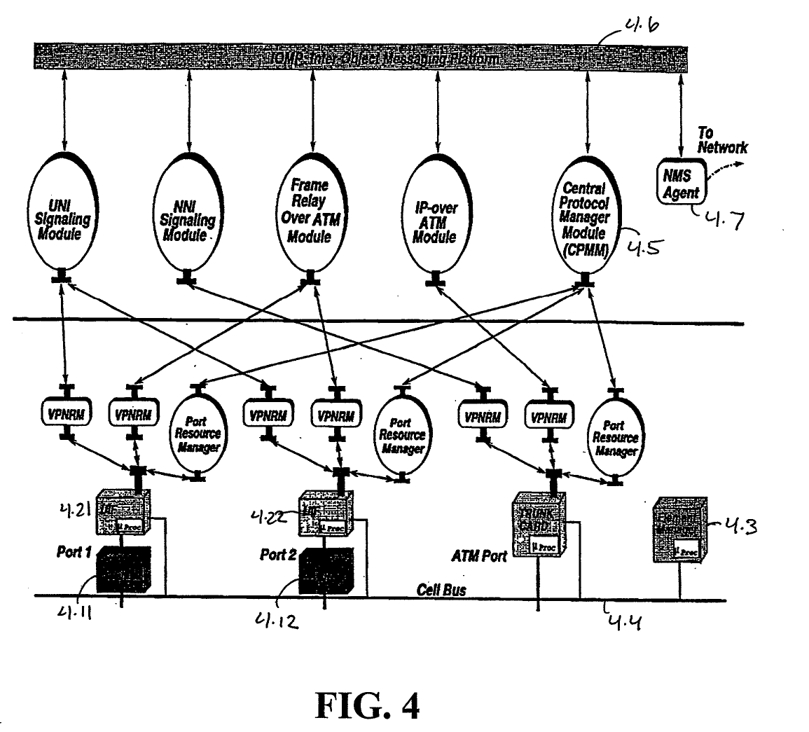

A preferred embodiment of software architecture of the present invention is shown in FIG. 4. The implementation is on a Flexible Programmable ATM Access Multiplexer platform, described in '610, which acts like a multi-processor switching device. Each port of the access multiplexer is divided into two physically separate cards, namely a Line Interface Card (LIF) 4.11 and a Universal Interface Card (UIF) 4.21. While the line interface card performs all line-specific operations (e.g. coding, line delimiting, line maintenance etc.), the UIF is responsible for higher layer protocol related functions, including, layer-3 protocol termination, cell queuing, traffic shaping and policing. UIF and LIF together provide the functionality of a switch port. The element manager card 4.3 is responsible for the local management-plane functions and also to communicate with the Network Management System (NMS) residing within the networks.

These switch-ports and the controller card (element manager card) communicate through an ATM cell bus 4.4. An ATM cell bus is chosen for optimizing the communication costs among the UIFs and the controller card. More about these cards and their functional descriptions can be found in '610. Note that each UIF 4.11-4.21 hosts a processor and since there are multiple UIFs present in the multiplexer, the device acts like a multi-processor switch. This particular hardware feature of the multiplexer makes it a suitable implementation platform for the VPN resource control architecture, of the present invention.

FIG. 4 depicts an integrated picture of all the necessary software components, running on multiple ports of the access multiplexer. Three new software components, namely, a Central Protocol Manager Module (CPMM) 4.5, an Inter Object Messaging Platform (IOMP) 4.6 and an NMS agent 4.7 are shown in FIG. 4. Each ATM Multiplexer contains a CPMM which is responsible for protocol downloading, internal processing and memory resource administration and other protocol related management activities. Each PRM talks to the CPMM through a special management interface. This interface is used for notifying a PRM about the necessary VPNRMs and their resource requirement information. The IOMP 4.6 provides a uniform inter-module communication interface within the ATM Multiplexer. This provides a clean function-call type communication interface. For implementing IOMP, a combination of permanent virtual circuits, operating system Inter Process Communication (IPC) calls, raw IP messages and Remote Procedure Calls (RPC) are used.

The NMS agent 4.7 runs within the element manager card and communicates with a designated NMS manager which resides within the network. The role of NMS agent is to coordinate local network management operations including VPN management, protocol downloading, device configuration, resource configuration, measurement and billing. More about VPN management by NMS agent is discussed in the next section.

### IV.D. VPN Management

Another aspect of the present invention is a switch resource and protocol management architecture for supporting Virtual Private Networks. Previous sections of this documents describe various components of the architecture and their interworking within a switching device. In this section, a mechanism for an external entity like a Network Management System (NMS) to create and configure the VPN support components within the switch is provided.

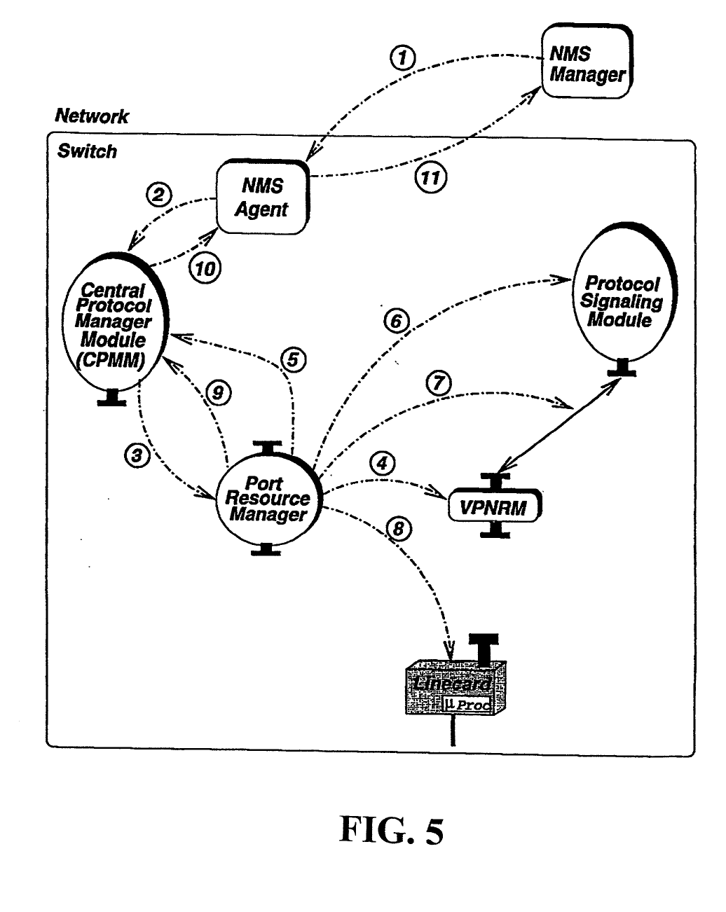

The process of VPN creation/configuration is described as a sequence diagram in FIG. 5. The circled numbers attached to each dotted arrow indicates the sequence of that operation. Note that the step number in the following description corresponds to the operation sequence number in the diagram. It is to be noted that all the internal communication is performed using the IOMP mechanism, described earlier.

1. An NMS manager instructs the switch NMS agent to create a VPN. This instruction comes with various VPN specific information, including VPN owner id., participating switch ports, duration of the VPN and required signaling/control protocols on each port. Usually, this process is triggered when a customer needs to create a VPN and contacts the NMS with its specific requirements. Note that a similar request can also be originated for reconfiguring/modifying an existing VPN.

2. NMS agent performs the authentication validation of the request and forwards it to the Central Protocol Manager Module (CPMM). At this stage, the CPMM processes the request and decides which ports are required to be configured by the VPN.

3. CPMM sends configuration requests to all the Port Resource Managers (PRMs) of the involved ports. For simplicity, transaction with only one port is shown in the FIG. 5. However in reality, similar transaction is carried out between the CPMM and all the appropriate PRMs. Detailed resource and protocol requirements are sent to the PRMs at this stage.

4. The PRM creates and configures required VPNRMs with specified amount of resources reserved for them. If sufficient amount of resources are not available then the PRM generates a fault message back to the CPMM which is finally relayed back to the appropriate customer through the network management system.

5. The PRM communicates with the CPMM to get a reference for the desired control protocol module within the switch. CPMM maintains a database of all such locally resident control modules. If the desired module is not available, then the CPMM downloads the required signaling module from the network. The download process is designed in the invention described in ***. At this stage, the CPMM provides the PRM with a reference to the desired control protocol module.

6. PRM passes the VPNRM configuration information to the necessary protocol signaling module.

7. A binding is created between a VPNRM and its control protocol signaling module.

Although the figure shows only one such instance, this operation is performed for all the created VPNRMs and their designated protocol signaling modules.

8. Control message demultiplexing information is sent to the switch line card. This information is used at the PHAI interface level for dispatching an incoming control message to the appropriate VPNRM.

9. Success or failure of the process is sent back to the CPMM.

10. Information conveyed in step 9 is sent back to the NMS agent

11. Information conveyed in step 10 is sent back to the NMS manager which, in turn, informs the initiating customer about the result of the VPN set up process.

Note that this architecture, together with the open ATM control mechanism described in *** is capable of executing this entire process dynamically and that is without affecting the operations of the existing VPNs which were already configured on the switch.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention. Further, acronyms are used merely to enhance the readability of the specification and claims. These acronyms should not be construed to restrict the scope of the claims to the embodiments described herein.

Further, acronyms are used merely to enhance the readability of the specification and claims. It should be noted that these acronyms are not intended to lessen the generality of the terms used and they should not be construed to restrict the scope of the claims to the embodiments described herein.

What is claimed is:

1. An ATM network system with an architecture for the implementation of resource and protocol management for supporting an overlay of one or more virtual private networks (VPN) within said ATM network, said system comprising:
partitioned port line resources for supporting said VPNs;
partitioned switch processing resources for supporting said VPNs;
a resource reserver for reserving resources for individual VPNs;
switch ports that can be configured for multiple control protocols;
protocol assignor for assigning control protocols to individual VPNs; and
a service creation manager for creating and deleting VPN services.

2. A virtual private network system comprising one or more VPNs, said one or more VPNs being overlaid on an ATM network, said VPN system allowing a customer to be present at a plurality of sites, wherein any ATM switch and any ATM port can be shared by a subset of said one or more VPNs, wherein two levels of multiprotocol support is provided, a first level of multiprotocol support being an ability for any VPN from said one or more of VPNs to choose any protocol without affecting VPNs different from said any VPN, a second level of multiprotocol support being an ability for any VPN from said one or more of VPNs to choose more than one protocol over a switch.

3. A virtual private network system comprising one or more VPNs being overlaid on an ATM network, wherein a port resource management layer (PRML) is provided between a line card and a signaling protocol controlling said line card, wherein said PRML provides a mechanism for logically partitioning available resources and bundling said resource into VPN specific resource modules (VPNRM), said VPNRMs being allocated to said VPNs.

4. The system of claim 3 wherein each of said VPNRMs is owned by one of said VPNs and said one of said VPNs is free to choose an authentication and security model for accessing available resources.

5. The system of claim 3 wherein each of said VPNRMs exports a VPN-specific secured interface (VSSI), said VSSI being used by a protocol signaling module for controlling partitioned resources owned by a VPN.

6. The system of claim 3 wherein each of said one or more VPNs is capable of using multiple control protocols on a same switch by creating a VPNRM each for each of said multiple control protocols.

7. The system of claim 3 wherein each of said one or more VPNs uses an independent control protocol on a switch by creating a VPNRM for said independent control protocol.

8. The system of claim 3 wherein each of said VPNRMs is registered with a protocol object by sending an allocated resource information corresponding to said each of said VPNRM to a protocol module, wherein said protocol module uses said resource information to allocate resources including VPI, VCI, buffers, cell-level scheduling priority and call admission control execution.

9. The system of claim 3 wherein when a connection setup message is received, a line card hardware delivers the message to an appropriate VSSI interface through an appropriate VPNRM, said appropriate VPNRM being chosen based on a specific control requirement corresponding to a VPN associated with the message.

10. The system of claim 9 wherein a VPNRM is chosen by partitioning an available VPI space and VCI space of a switch port and selecting a VPNRM within the VPN associated with the message using additional information within the message itself.

11. The system of claim 3 further comprising a network management system (NMS) on the network and an NMS agent that runs within an element manager card, wherein said NMS agent and NMS manager communicate with each other and said NMS agent coordinates local network management operations including VPN management, protocol downloading, device configuration, resource configuration, measurement and billing.

12. A method of creating VPN services in a VPN system comprising a central protocol manager module, a plurality of port resource managers (PRM) , a plurality of VPNRMs, a protocol signaling module, a line card, a Network Management System (NMS) manager and an NMS agent, said method comprising:
instructing the NMS agent by the NMS manager for creating the VPN and providing VPN-specific information;
performing authentication and validation by the NMS agent and forwarding a request to said CPMM;
sending configuration request from the CPMM to said plurality of PRMs;
configuring the plurality of VPNRMs by the PRMs with specified amount of resources required and sending a fault message if the resources are not available;
communicating with the CPMM by the PRMs to obtain a reference for a desired control protocol module for a switch;
passing the VPNRM configuration information by the PRMs to the protocol signaling module;
creating binding between said VPNRMs and corresponding signaling modules;
sending control message demultiplexing information to the line card; and
sending information on success or failure to the CPMM, NMS agent and NMS manager
